(19) United States
(12) Patent Application Publication
(10) Pub. No.: US 2004/0043199 A1
(43) Pub. Date: Mar. 4, 2004

(54) Lithographic ink composition

(75) Inventors: Raymond J. Farm, White Bear Lake, MN (US); Eser Ozdeger Donovan, Prescott, WI (US); Michael D. Crandall, North Oaks, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/228,717

(22) Filed: Aug. 27, 2002

(51) Int. Cl. C09D 11/00

(52) U.S. Cl. 428/195.1; 106/31.32; 106/31.6; 106/31.35; 106/31.67

(57) ABSTRACT

A releasable lithographic ink composition comprising (a) air-curable lithographic inks and (b) a release additive. The preferred additives to the air curable inks are combinations of lecithin and components having release functionality that cover a wide range of chemical structures. Functional moieties include silicones, long chain hydrocarbons, and fluorocarbons. In addition, the additive may also contain a moiety which has the ability to interact with the anionic and/or cationic sites of the lecithin. Moieties that can interact with the anionic site are cationic species such as, but not limited to, zinc, sodium, calcium, and quaternary ammonium. Moieties that can interact with the cationic site on the lecithin are anionic species such as, but not limited to, carboxylic acids (and their salts), sulfates, sulfonates, and phosphates.

### FIELD OF THE INVENTION

This invention relates to lithographic inks and particularly to air curable lithographic inks containing an agent to improve release characteristics.

### BACKGROUND OF INVENTION

Lithographic, flexographic or gravure printing processes are often used to prepare printed articles such as papers, films, labels, tapes and repositionable notes. In the printing industry, modifying agents are used to alter the “slip” or “blocking resistance” of the sheet. These traditional ink additives include polyethylene, polypropylene or polytetrafluoroethylene (such as Teflon) particles or waxes. Silicone additives are generally avoided as they can cause ink-wetting problems on the print rollers or plates and adversely affect transfer of ink from the printing plate to the substrate and print quality. The theory is that these particles form domains on the surface of the cured ink and by their inherent properties reduce contact of the ink to the adjacent surface. Although some of these materials may show value in simple paper systems, printed stock which has a pressure sensitive adhesive coating thereon produces a construction in which these traditional “slip” agents do not function effectively.

Repositionable note pads, tapes and linerless labels typically consist of sheets of stock (paper, films, etc.) coated with pressure sensitive adhesive (“PSA”) (and optionally a primer) on one side of the sheet and a release coating (also referred to as “low adhesion backsize” or “LAB”) on the other side. In either pad (stacked sheets) or roll form, the release coating is in contact with the adhesive. In pad form, the release coating is used to lower the force required to remove the adhesive from the adjacent sheet in order to facilitate dispensing and minimize stock deformation or curl. In roll form, the release coating is used to ensure easy unwind during processing and dispensing.

Lithographic, flexographic or gravure printing processes are often used to prepare printed repositionable notes, tapes and linerless labels. Often, the printing process is separate from and subsequent to the process that applies the adhesive and release coating.

In such situations, a roll of stock that has been pre-coated with adhesive and a release material is routed through a printing press, ink is printed on top of the release coating, and the printed material is immediately either rolled back up or cut into a stack of discrete sheets. Printing of ink over the release coating renders the release coating ineffective. Undesirable adhesive-ink interactions are also formed which results in poor release (high unwind, tear outs, poor dispensing) and transfer of ink from the printed stock to the adhesive. Such “ink transfer” damages the printed image and contaminates the adhesive. In addition there may also be adhesive transfer to the ink surface.

It is an object of this invention to overcome such shortcomings in the manufacture of printed articles. Furthermore silicone materials which commonly are avoided can be used in conjunction with one aspect of this invention without the deleterious side effects. This invention is also easy to practice and with limited economic impact on the printed product.

To date, it is believed that no references describe the addition of lecithin or combinations of lecithin and agents containing certain release capabilities to effect the desired release characteristic of a lithographic, flexographic, or gravure ink and resultant printed product.

### SUMMARY OF INVENTION

Briefly in one aspect of the present invention, releasable lithographic inks that provide release characteristics to printed inks are provided comprising (a) air-curable lithographic inks and (b) a release additive. The preferred additives to the air-curable inks are combinations of lecithin and components having release functionality.

Inks containing additives such as lecithin and lecithin combinations can be advantageously used in products that have pressure sensitive adhesives (PSAs) in contact with the printed inks in order to reduce undesirable PSA/ink interactions.

Undesirable PSA/ink interactions that are avoided by this invention include “ink transfer” from the printed image to the adhesive which results in damage to the printed image and adhesive contamination, high release forces during unwind or sheet removal which can cause damage to the backing or render the product unusable, and adhesive transfer from the notepaper to the ink surface of the printed image.

In another aspect of the present invention, adhesive coated articles are provided comprising (a) a backing substrate having a front and back surface, (b) a layer of pressure sensitive adhesive on at least one portion of the back surface of the backing substrate, and (c) indicia on the front surface of the backing substrate, wherein the indicia is printed using lithographic inks having release characteristics.

Furthermore, in yet another aspect of the present invention, a pad assembly is provided comprising a multiplicity of flexible sheets each having similarly sized body portion that have pressure sensitive adhesive on the back surface and indicia printed on the front surface, wherein the indicia is printed with lithographic inks having release characteristics, such that when a sheet is removed from the pad assembly, the sheet is easily removable and the lithographic ink is not transferred from the front of the sheet of a first sheet to the back of the sheet of second sheet overlaying the first sheet. The multiplicity of sheets have pressure sensitive adhesive coated onto the back surface of the sheets and the sheets are disposed in a stack with the corresponding peripheral edges of the body portions of the sheets aligned and the pressure sensitive adhesive of each sheet adhering that sheet to the adjacent sheet in the stack. Such products include printed repositionable note pads (such as 3M Post-it® Notes), linerless labels, printed pressure sensitive tapes, adhesive coupons, and the like.

Advantageously, using lithographic inks having release characteristics provides a construction that eliminates the need of providing a release coating on sheets having indicia printed on the front of them.

In a further aspect of the present invention, a method of using lithographic inks having release characteristics are provided comprising the steps of:

(a) blending an air-curable printing ink with an appropriate weight percent of an additive that functions as a release coating; (b) printing the blended ink onto a substrate having a front and back surface, such that the printing is positioned on the front surface of the substrate coincident with the adhesive coating applied on the back surface of the substrate; (c) stacking the printed substrates into a pad or winding the printed substrate onto a roll core.

### DESCRIPTION OF THE PREFERRED EMBODIMENT(S)

In this invention, ink additives have been discovered that eliminate the aforementioned problems of poor release, high “ink transfer”, and adhesive transfer. The additives can be blended with commercially available air-curable lithographic inks and the resultant inks printed using standard lithographic printing processes.

Lecithin is a glycerine based phospholipid derived from natural products such as soy beans. Compounds with similar structure may function in the same manner as described here. These compounds include sphingomyelin, fatty acid esters of phosphorylated diethanolamine or triethanolamine, fatty acid soaps of monovalent, divalent, and trivalent ions such as NH₄⁺, Na⁺, K⁺, Mg⁺⁺, Ca⁺⁺, Zn⁺⁺, and Al⁺⁺⁺, and various fatty acids from C₈ to C₂₂, both saturated and unsaturated. Lecithin is preferred since it is readily available, inexpensive, environmentally friendly, biodegradable and physically compatible with the printing ink components.

The agents having release properties cover a wide range of chemical structure. Functional moieties include silicones, long chain hydrocarbons, and fluorocarbons. In addition, the agent may also contain a moiety that has the ability to interact with the anionic and/or cationic sites of the lecithin. Moieties that can interact with the anionic site are cationic species such as, but not limited to, zinc, sodium, calcium, and quaternary ammonium. Moieties that can interact with the cationic site on the lecithin are anionic species such as, but not limited to, carboxylic acids (and their salts), sulfates, sulfonates, and phosphates.

While not to be bound by theory, it is believed that the unsaturated fatty acid portion of the lecithin group of the additive has the potential for entering into the curing processes of both air-curable and UV-curable lithographic inks and becoming covalently bound to the cured ink. The bound additive will not transfer to and contaminate pressure sensitive adhesives that may come in contact with the ink.

The preferred additive is a combination of lecithin and zinc stearate. The ratio of lecithin to zinc stearate encompasses the range from 1:1 to 5:1. The addition of lecithin alone has also been shown to possess beneficial release properties.

The additive is added to the ink in amounts ranging from 0. 1 to 25% by weight of the ink and preferably between 3 and 20%. The optimum additive amount will be dependent on the adhesion level of the pressure sensitive adhesive and desired release value in the printed product. Addition of too much additive can cause wetting problems on the print rollers and blankets and adversely affect the printing process.

Traditional ink additives such as polyolefin and polytetrafluoroethylene (such as Teflon) waxes and particles have been found to be ineffective. Also ineffective are fluoroacrylate compounds such as Fluorad™ FX-189, Fluorad™ FX-13 and Fluorad™ FX-14 that are commercially available from 3M Company, St. Paul, Minn.

Preferable lithographic inks are curable by air-oxidation although lithographic inks that are curable by UV irradiation may also be used. Typical lithographic inks that are commercially available from common ink suppliers can be used.

Suitable air-curable lithographic inks include soy-based process inks from Kohl and Madden Corporation such as Lithographic Soy ABDT Black MSP-42200-D-STG-5 (tack=16), PMS-185-ABD (OFF-ABD-STD-RED), and MSP-42200-D-STG-S (OFF-SOY-ABDT-BLACK). Additional examples of suitable inks include Note Pad Process Black K52-3444-22 commercially available from Central Ink Corporation (Plymouth, Minn.).

Suitable UV-curable lithographic inks include UV I/D process inks form Kohl and Madden Corporation (Minneapolis, Minn.), and UVALUX process inks from Zeller Interchern Corporation (2205 Tomlynn Street, Richmond, Va. 23230.

Standard lithographic printing presses can be used. Such presses for air-curable inks include: Didde's (Emporia, Kans.) Webcom and Apollo presses and printing presses available from Stevens International (Fort Worth, Tex.). Laboratory presses include the Little Joe Proving Press (Little Joe Color Swatcher, Somerville, N.J.). UV Presses include those available from Sanden (Cambridge, Ontario) and Mueller Martini (New York).

### EXAMPLES

This invention is further illustrated by the following examples that are not intended to limit the scope of the invention. In the examples, all parts, ratios and percentages are by weight unless otherwise indicated. The following test methods were used to evaluate and characterize the printing ink with additives compositions produced in the examples. All materials are commercially available, for example from Aldrich Chemicals (Milwaukee, Wis.), unless otherwise indicated or described.

### Test Methods

Sheet Removal Force

The sheet removal force test is used to measure the amount of force required to remove the adhesive coated paper sheet from the underlying area of printed paper sheet.

A two sheet stack to be tested is applied to a steel test panel with Scotch 410 double sided adhesive tape. This test plate is clamped into the lower jaws of a tensile testing machine that is capable of moving the plate away from the load cell at a constant rate of twelve inches (30.48 cm) per minute. The top layer of the two sheet sample is clamped to the upper jaw of the tensile testing machine. The position of the test plate is adjusted during this test movement such that the peel angle remains at 90 degrees. The force to remove the upper adhesive stripe sheet from the lower printed surface sheet is measured by a load cell and the results tabulated by computer. The values reported are in units of grams per one inch width. The values are the average of 4-6 tests.

The removed adhesive sheet that has been in contact with the ink printed area is tested for adhesion to bond paper to determine the adhesion to bond paper (ink contacted). The removed adhesive sheet that has not been in contact with the ink printed area is tested for adhesion to bond paper to determine the adhesion to bond paper (not ink contacted).

Peel Adhesion to Bond Paper

Peel adhesion is the force required to remove a coated sheet from a bond paper substrate at a specific angle and rate of removal. In the examples this force is expressed in grams per one-inch width of coated sheet. The procedure followed is:

A strip, one inch wide, of coated sheet is applied to the horizontal surface of 20-pound bond paper. A 4.5 lb. hard rubber roller is used to firmly apply the strip to the bond paper. The free end of the coated sheet is attached to the adhesion tester load cell such that the angle of removal will be 90 degrees. The test plate is then clamped in the jaws of the tensile testing machine that is capable of moving the plate away from the load cell at a constant rate of 12 inches per minute. A load cell reading in grams per inch of coated sheet is recorded.

Purchased Materials

| | |
|---|---|
| Abil S-201 and Abil B-9950 | Goldschmidt Chemical Corporation |
| (silicone surfactants 30% | Hopewell, VA |
| active) | |
| Centrol 3FSB (lecithin) | Central Soya Company |
| | Fort Wayne, IN |
| Sodium Stearate | American International Chemical, Inc. |
| | Natick, MA |
| Zinc Stearate | Aldrich Chemical Company, Inc. |
| | Milwaukee, WI |
| MSP 52704-HD; MSP 69343 | Kohl & Madden Printing Ink Corporation |
| (coldset inks) | Minneapolis, MN |
| INX 1087619 | Inx International |
| (coldset ink) | Arden Hills, MN |
| Sodium Oleate | TCI |
| | Japan |
| Lauric Acid | Eastman Kodak Company |
| | Rochester, NY |
| Sodium Hydroxide | Mallinkrodt Specialty Chemicals |
| | Company |
| | Paris, KY |
| Zinc Chloride | Aldrich Chemical Company, Inc. |
| | Milwaukee, WI |
| Stearic Acid | EM Science |
| | Gibbstown, NJ |
| Docosanoic Acid | Eastman Organic Chemicals |
| | Rochester, NY |
| Calcium Chloride | Fisher Scientific Company |
| | Fair Lawn, NJ |
| Linseed Oil | Aldrich Chemical Company, Inc. |
| | Milwaukee, WI |

Synthesis of Materials

Zinc Oleate—In a large crystallizing dish 76.0 grams sodium oleate was dissolved in approximately 200 milliliters water. 300 milliliters of ethanol was then added and the mixture stirred. In a separate container 17.125 grams of zinc chloride was dissolved in approximately 200 milliliters water. This was added to the sodium oleate solution under constant agitation. The white precipitate of zinc oleate was further diluted with water and then ground to a fine particle size using a high-speed homogenizer. The resultant material was filtered through Whatman No.1 filter paper in a Buchner funnel. The insoluble material retained on the filter paper was washed by passing distilled water through the filter cake. The filtrate was then spread in an aluminum pan and allowed to air dry. The zinc oleate was further dried for 2 hours in a vacuum oven at 40-50 C. It was then passed through an U.S. Standard Sieve No. 30.

Zinc Laurate—In a large crystallizing dish 50.09 grams lauric acid was dissolved in 250 milliliters warm ethanol. To this was added a solution of 10.05 grams sodium hydroxide in 100 milliliters water to form sodium laurate. 400 milliliters water was then added and the mixture stirred. A solution of 17.034 grams zinc chloride dissolved in 100 milliliters water was then added while stirring. The resultant material was filtered through Whatman No.1 filter paper in a Buchner funnel. The insoluble material retained on the filter paper was washed by passing distilled water through to remove any sodium chloride. The filtrate was then spread in an aluminum pan and allowed to air dry. The zinc laurate was further dried for 3-4 hours in a vacuum oven at 72 C. It was then passed through an U.S. Standard Sieve No. 30.

Calcium Stearate—In a large crystallizing dish 71.12 grams stearic acid was dissolved in 250 milliliters of warm ethanol. To this was added a solution of 10.03 grams sodium hydroxide in 100 milliliters water to form sodium stearate. A solution of 18.38 grams calcium chloride dissolved in 100 milliliters water was then added while stirring. This mixture was thinned by addition of 800 milliliters water while stirring. The resultant material was filtered through Whatman No.1 filter paper in a Buchner funnel. The insoluble material retained on the filter paper was washed by passing distilled water through the filter cake. The filtrate was then spread in an aluminum pan and allowed to air dry. The calcium stearate was further dried for 3-4 hours in a vacuum oven at 72 C. It was then passed through an U.S. Standard Sieve No. 30.

Zinc Docosanoate—In a large crystallizing dish 85.13 grams docosanoic acid was dissolved in 300 milliliters of warm ethanol. To this was added a solution of 9.998 grams sodium hydroxide in 200 milliliters water to form sodium docosanoate. 300 milliliters water was then added and the mixture stirred. A solution of 17.034 grams zinc chloride dissolved in 200 milliliters water was then added while stirring. The resultant material was filtered through Whatman No.1 filter paper in a Buchner funnel. The insoluble material retained on the filter paper was washed by passing distilled water through the filter cake. The filtrate was then spread in an aluminum pan and allowed to air dry. The zinc docosanoate was further dried for 3-4 hours in a vacuum oven at 72 C. It was then passed through an U.S. Standard Sieve No. 30.

Reference for Microsphere Adhesive

U.S. Pat. No. 5,756,625 Ionically Stabilized Microspheres

After the removable adhesive coated stock is printed with the ink formulation, pads are formed by stacking several sheets such that an adhesive stripe crosses from the unprinted zone through the printed zone and back onto an unprinted zone. The stacks are pressed together using a hydraulic press with 800 pounds psig for thirty seconds. These samples are then used to test for sheet removal force, adhesion to bond paper (no ink contact) and adhesion to bond paper (ink contacted).

### Example 1

Into a glass jar 46.13 grams Centrol 3FSB lecithin (part A) was weighed. To this was added 28.87 grams zinc stearate (part B). Using a metal spatula the zinc stearate was mixed into the lecithin until a uniform thick mixture resulted. The ratio of part A to part B in this example is 1.60:1. To make a 15% addition of additive this entire mixture was added to 500 grams of Kohl & Madden MSP 52704-HD ink. This was mixed using a metal spatula until a uniform mixture was formed. This sample was then printed onto the removable notepaper and tested for performance using the test methods described above.

### Example 2-9

The modified ink samples were made in the same manner as Example 1 except that the additive was made according to Table 1.

TABLE 1

| Ex. No. | Part A: | Part B: | Part A:Part B | % Additive |
|---|---|---|---|---|
| 2 | Lecithin | Zinc docosanoate | 1.36:1 | 15% |
| 3 | Lecithin | Zinc laurate | 2.18:1 | 15% |
| 4 | Lecithin | Zinc oleate | 1.61:1 | 15% |
| 5 | Lecithin | Calcium stearate | 1.66:1 | 15% |
| 6 | Lecithin | Sodium stearate | 3.30:1 | 15% |
| 7 | Lecithin | Stearic acid | 3.56:1 | 15% |
| 8 | Lecithin | Docosanoic acid | 2.97:1 | 15% |
| 9 | Lecithin | Oleic acid | 3.58:1 | 15% |

Comparative Examples C1 and C2

| Ex. No. | Part A: | Part B: | Part A:Part B | % Additive |
|---|---|---|---|---|
| C1 | None | Zinc stearate | NA | 6% |
| C2 | None | None | NA | 0% |

The testing results of Examples 1-9 and C1-C2 are seen in Table 2.

TABLE 2

| Ex. No. | SRF(g/in) | Adh-Bond(g/in) |
|---|---|---|
| 1 | 37.8 | 23.4 |
| 2 | 63.6 | 26.4 |
| 3 | 61.4 | 24.0 |
| 4 | 48.2 | 22.1 |
| 5 | 59.4 | 25.6 |
| 6 | 47.1 | 25.1 |
| 7 | 54.8 | 24.9 |
| 8 | 74.0 | 25.7 |
| 9 | 60.4 | 22.4 |
| C1 | 97.1 | 25.2 |
| C2 | 98.8 | 27.0 |

Notes: SRF is sheet removal force;
Adh-Bond is adhesion to bond paper; the adhesive used in these examples is basic [IOA/NVP/NaSS (99/0.5/0.5)]

### Examples 10-13

These samples were prepared by first mixing together the two components, then placing in a vacuum oven at room temperature for two hours to remove volatiles. The additive was then added to the ink and thoroughly mixed. See Table 3.

TABLE 3

| Ex. No. | Part A: | Part B: | Part A:Part B | % Additive |
|---|---|---|---|---|
| 10 | Lecithin | Abil S-201 | 1.67:1* | 3% |
| 11 | Lecithin | Abil S-201 | 1.67:1* | 6% |
| 12 | Lecithin | Abil B 9950 | 1.67:1* | 3% |
| 13 | Lecithin | Abil B 9950 | 1.67:1* | 6% |
| C3 | None | None | NA | 0% |

*based on active content of the Abil materials

The testing results of Examples 10-13 and C3 are seen in Table 4.

TABLE 4

| Ex. No. | SRF(g/in) | Adh-Bond(g/in) |
|---|---|---|
| 10 | 184.5 | 25.6 |
| 11 | 164.3 | 25.1 |
| 12 | 187.5 | 24.4 |
| 13 | 145.1 | 26.7 |
| C3 | 231.5 | 26.9 |

Notes: SRF is sheet removal force;
Adh-Bond is adhesion to bond paper; the adhesive used in these examples is acidic [IOA/AA/NaSS (99/0.5/0.5)]

### Examples 14-15

The additives for these examples were prepared as in Example 1. See Table 5.

TABLE 5

| Ex. No. | Part A: | Part B: | Part A:Part B | % Additive |
|---|---|---|---|---|
| 14 | Linseed Oil | Zinc stearate | 1.94:1 | 15% |
| 15 | Lecithin | Zinc stearate | 1.60:1 | 15% |
| C4 | None | None | NA | 0% |

The testing results of Examples 14-15 and C4 are seen in Table 6.

TABLE 6

| Ex. No. | SRF(g/in) | Adh-Bond(g/in) |
|---|---|---|
| 14 | 140.1 | 37.6 |
| 15 | 79.4 | 40.0 |
| C4 | 173.6 | 39.9 |

Notes: SRF is sheet removal force;
Adh-Bond is adhesion to bond paper; the adhesive used in these examples is acidic [IOA/AA/NaSS (99/0.5/0.5)]

### Examples 16-18

The additives for these examples were prepared as in Example 1. See Table 7.

TABLE 7

| Ex. No. | Part A: | Part B: | Part A:Part B | % Additive |
|---|---|---|---|---|
| 16 | Lecithin | Zinc stearate | 1.60:1 | 7.5% |
| 17 | Lecithin | Zinc stearate | 1.60:1 | 15% |
| 18 | Lecithin | Zinc stearate | 1.60:1 | 22.5% |
| C5 | None | None | NA | 0% |

The testing results of Examples 16-18 and C5 are seen in Table 8.

TABLE 8

| Ex. No. | SRF(g/in) | Adh-Bond(g/in) |
|---|---|---|
| 16 | 68.7 | 28.3 |
| 17 | 37.8 | 23.4 |
| 18 | 34.9 | 25.4 |
| C5 | 98.8 | 27.0 |

Notes: SRF is sheet removal force;
Adh-Bond is adhesion to bond paper; the adhesive used in these examples is basic [IOA/NVP/NaSS (99/0.5/0.5)]

### Examples 19-21

The additives for these examples were prepared as in Example 1. See Table 9.

TABLE 9

| Ex. No. | Part A: | Part B: | Part A:Part B | % Additive |
|---|---|---|---|---|
| 19 | Lecithin | Zinc stearate | 1.60:1 | 15% |
| 20 | Lecithin | Oleic acid | 3.58:1 | 15% |
| 21 | Lecithin | None | NA | 9% |
| C6 | None | Zinc stearate | NA | 6% |
| C7 | None | Oleic acid | NA | 6% |
| C8 | None | None | NA | 0% |

The testing results of Examples 19-21 and C6-C8 are seen in Table 10.

TABLE 10

| Ex. No. | SRF(g/in) | Adh-Bond(g/in) |
|---|---|---|
| 19 | 59.0 | 25.5 |
| 20 | 57.0 | 21.1 |
| 21 | 61.0 | 21.3 |
| C6 | 112.0 | 32.9 |
| C7 | 118.0 | 30.9 |
| C8 | 89 | 22.7 |

Notes: SRF is sheet removal force;
Adh-Bond is adhesion to bond paper; the adhesive used in these examples is basic [IOA/NVP/NaSS (99/0.5/0.5)]

### Example 22

The additives for these examples were prepared as in Example 1 with the exception that the ink used was Kohl&Madden MSP 69343. See Table 11.

TABLE 11

| Ex. No. | Part A: | Part B: | Part A:Part B | % Additive |
|---|---|---|---|---|
| 22 | Lecithin | Zinc stearate | 1.60:1 | 15% |
| C9 | None | None | NA | 0% |

The testing results of Examples 22 and C9 are seen in Table 12.

TABLE 12

| Ex. No. | SRF(g/in) | Adh-Bond(g/in) |
|---|---|---|
| 22 | 78.6 | 41.1 |
| C9 | 129.5 | 39.2 |

Notes: SRF is sheet removal force;
Adh-Bond is adhesion to bond paper; the adhesive used in these examples is basic [IOA/NVP/NaSS (99/0.5/0.5)]

### Example 23-24

The additives for these examples were prepared as in Example 1 with the exception that the ink used was Inx International INX 1087619. See Table 13.

TABLE 13

| Ex. No. | Part A: | Part B: | Part A:Part B | % Additive |
|---|---|---|---|---|
| 23 | Lecithin | Zinc stearate | 1.60:1 | 7.5% |
| 24 | Lecithin | Zinc stearate | 1.60:1 | 15% |
| C10 | None | None | NA | 0% |

The testing results of Examples 23-24 and C10 are seen in Table 14.

TABLE 14

| Ex. No. | SRF(g/in) | Adh-Bond(g/in) |
|---|---|---|
| 23 | 72.6 | 25.3 |
| 24 | 61.3 | 20.1 |
| C10 | 97.2 | 22.3 |

Notes: SRF is sheet removal force;
Adh-Bond is adhesion to bond paper; the adhesive used in these examples is basic [IOA/NVP/NaSS (99/0.5/0.5)]

Various modifications and alterations of this invention will become apparent to those skilled in the art without departing from the scope and principles of this invention, and it should be understood that this invention is not to be unduly limited to the illustrative embodiments set forth hereinabove. All publications and patents are incorporated herein by reference to the same extent as if each individual publication or patent was specifically and individually indicated to be incorporated by reference.

What is claimed:

1. A lithographic ink composition comprising:
(a) an air curable lithographic ink, and
(b) an ink additive comprising
(i) first release agent comprising
(1) at least one saturated or unsaturated alkyl chain C8 or greater and
(2) at least one zwitterionic moiety, and
(ii) optionally, a second release agent, different than the first release agent.

2. The lithographic ink composition according to claim 1, wherein the first release agent is a phospholipid structure.

3. The lithographic ink composition according to claim 2, wherein the phospholipid structure is glycerine based.

4. The lithographic ink composition according the claim 3, wherein the glycerine based phospholipid structure is a lecithin or a mixture of lecithins.

5. The lithographic ink composition according to claim 1, including the second release agent, wherein the second release agent is selected from the group consisting of silicones, long chain hydrocarbons, and fluorocarbons.

6. The lithographic ink composition according to claim 1, including the second release agent, wherein the second release agent is a fatty acid soap.

7. The second release agent according to claim 6, wherein the fatty acid soap is zinc stearate.

8. The lithographic ink composition according to claim 5, wherein the ratio between the first release agent and the second release agent is in the range of 1:1 to 5:1.

9. The lithographic ink composition according to claim 6, wherein the ratio between the first release agent and the second release agent is in the range of 1:1 to 5:1.

10. The lithographic ink composition according to claim 1, wherein the ink additive is in the range 0.1 to 25% by weight of the ink composition.

11. An adhesive coated article comprising (a) backing substrate having a front and back surface, (b) a layer of pressure sensitive adhesive on at least one portion of the back substrate, and (c) indicia on at least one portion of the backing substrate, wherein the indicia is printed using a releasable lithographic ink comprising:
(a) an air curable lithographic ink, and
(b) an ink additive comprising
(i) first release agent comprising
(1) at least one saturated or unsaturated alkyl chain C8 or greater and
(2) at least one zwitterionic moiety, and
(ii) optionally, a second release agent, different than the first release agent.

12. The adhesive coated article according to claim 11, wherein the first release agent is a phospholipid structure.

13. The adhesive coated article according to claim 12, wherein the phospholipid structure is glycerine based.

14. The adhesive coated article according the claim 13, wherein the glycerine based phospholipid structure is a lecithin or a mixture of lecithins.

15. The lithographic ink composition according to claim 1, including the second release agent, wherein the second release agent is selected from the group consisting of silicones, long chain hydrocarbons, and fluorocarbons.

16. The adhesive coated article according to claim 11, including the second release agent, wherein the second release agent is a fatty acid soap.

17. The second release agent according to claim 16, wherein the fatty acid soap is zinc stearate.

18. The adhesive coated article according to claim 15, wherein the ratio between the first release agent and the second release agent is in the range of 1:1 to 5:1.

19. The adhesive coated article according to claim 16, wherein the ratio between the first release agent and the second release agent is in the range of 1:1 to 5:1.

20. The adhesive coated article according to claim 11, wherein the ink additive is in the range 0.1 to 25% by weight of the ink composition.

21. A pad assembly comprising a multiplicity of flexible sheets each having similarly sized body portion that have pressure sensitive adhesive on a back surface and indicia printed on a front surface, wherein the indicia is printed with lithographic inks having release characteristics, such that when a sheet is removed from the pad assembly, the sheet is easily removable and the lithographic ink is not transferred from the front of the sheet of a first sheet to the back of the sheet of second sheet overlaying the first sheet, wherein the lithographic ink comprises:
(a) an air curable lithographic ink, and
(b) an ink additive comprising
(i) first release agent comprising
(1) at least one saturated or unsaturated alkyl chain C8 or greater and
(2) at least one zwitterionic moiety, and
(ii) optionally, a second release agent, different than the first release agent.

22. A roll of adhesive material comprising a substrate having at least one portion that has a pressure sensitive adhesive on a back surface and indicia printed on a front surface, wherein the indicia is printed with lithographic inks having release characteristics, such that when the material is unrolled from the roll, the material is easily removable and the lithographic ink is not transferred from the front of the substrate, wherein the lithographic ink comprises:
(a) an air curable lithographic ink, and
(b) an ink additive comprising
(i) first release agent comprising
(1) at least one saturated or unsaturated alkyl chain C8 or greater and
(2) at least one zwitterionic moiety, and
(ii) optionally, a second release agent, different than the first release agent.
